(19) United States
(12) Patent Application Publication
(10) Pub. No.: US 2013/0210500 A1
(43) Pub. Date: Aug. 15, 2013

(54) POWER BOOSTERS FOR RADIO TERMINALS

(71) Applicant: TAIT LIMITED, (US)

(72) Inventors: Ian Myrus GRAHAM, North Canterbury (NZ); James Kennedy CAVERS, British Columbia (CA); Mark William COTTON, Avonhead (NZ)

(73) Assignee: TAIT LIMITED, Christchurch (NZ)

(21) Appl. No.: 13/763,531

(22) Filed: Feb. 8, 2013

Related U.S. Application Data
(60) Provisional application No. 61/597,154, filed on Feb. 9, 2012.

(51) Int. Cl. H04W 52/30

(52) U.S. Cl. CPC H04W 52/30
USPC 455/571

(57) ABSTRACT

A conventional UE in a radio system based on LTE may be boosted for use in an extended geographical cell provided by an eNodeB. The booster may be connected to the UE in various ways which minimise the changes required to an otherwise standard UE device. The booster is activated by control signals from the UE, or by an internal switch, or by a power detector for example. Power headroom reports by the UE to the eNodeB are correct within the larger cell.

### CROSS-REFERENCE TO RELATED APPLICATIONS

This application claims priority to U.S. Provisional Patent Application Ser. No. 61/597,154 entitled “Power Boosters for Radio Terminals,” filed on 9 Feb. 2012, the disclosure of which is incorporated herein by reference in its entirety.

### FIELD OF THE INVENTION

This invention relates to high capacity wireless communication networks such as LTE (3GPP Long Term Evolution). Particularly to use of LTE in mobile radio networks for public utilities or involving public safety.

### BACKGROUND TO THE INVENTION

The LTE standard is designed to provide flexible, high capacity wireless communication for commercial users but is also being adapted for public safety systems. Public safety systems have notable differences compared to commercial systems, such as lower user density, an expectation of a higher quality of service and priority access, and greater cell sizes involving greater coverage areas and data rates. In these larger cell sizes, there is a need for each radio terminal or UE (“User Equipment”) to transmit at a higher power level than for a commercial system.

LTE systems use dynamic UE power control such that the received signal levels from all the terminals related to a particular base station (or “eNodeB”) are roughly the same. This is critical in CDMA systems to prevent the classic near/far problem where stronger signals from terminals close to the base-station can swamp weaker signals from more distant terminals to the point where the weaker become undetectable. In LTE and other OFDMA systems the problem is less important because the uplink SC-FDMA signal from each UE is separated in both time and frequency. However, there are still detailed definitions of power control involving upwards of 9 parameters that cover the PUCCH (Uplink Control Channel), PUSCH (Uplink Shared Channel, for data payload) and Reference Signals (RS).

An LTE network assesses the data throughput capabilities of the terminals on the system via the power headroom report (PHR) that each UE periodically sends via the base station serving the local cell. The network can then determine both a bandwidth (ie: the number of 180 kHz wide Resource Blocks, M) and a modulation coding scheme (MCS) for each UE to maximize data throughput while at the same time optimising the interference management of the network. If the power headroom reports are too low, for example, data throughput could be significantly below optimum levels.

Power Headroom is a prediction of the difference between the maximum UE power output permitted in a particular cell (Pmax) and the uplink power required for a particular data throughput, rather than a measure of the difference between Pmax and actual UE output power. The present limits in ETSI TS 136 101 for the UE transmission power are for a commercial system, ie: Pmax=+23 dBm, Pmin=−40 dBm, transmitter ‘off’ power=−50 dBm.

Power headroom reports can therefore range from +40 to −23 dB. If a UE reports negative power headroom, this means that the terminal has received an uplink grant containing a modulation and coding scheme and a number of resource blocks that would require more output power than the UE has available. The network could then reduce the number of resource blocks allocated to the particular terminal, and grant the remainder to other terminals, ensuring system capacity is not wasted.

### SUMMARY OF THE INVENTION

It is an object of the invention to provide for improved management of data throughput and interference between terminals in radio networks having relatively large cell sizes.

In one aspect the invention may be said to reside in a radio for use in a mobile radio network, including: a user terminal having a transceiver, a power controller and an antenna; and a power booster having an amplifier and an amplifier bypass, under control of the user terminal; wherein the booster is coupled between the transceiver and the antenna to form a signal path for transmission of radio signals by the terminal, and the power controller switches the signal path between the amplifier and the amplifier bypass according to transmitter power required from the user terminal. Preferably the power controller switches the booster into the signal path when the required transmitter power reaches a maximum power available from the transceiver, and correspondingly decreases the power provided by the transceiver. The power controller then switches the booster out of the signal path when the required transmitter power is available from the transceiver alone. The power controller generates a power headroom report which includes power available from the booster.

In another aspect the invention resides in a radio for use in a mobile radio network, including: a user terminal having a transceiver, a power controller and an antenna; and a power booster having an amplifier which is coupled between the transceiver and the antenna to form a signal path for transmission of radio signals by the terminal to the network, wherein the power controller generates a power headroom report for the network including the power available from the booster.

In a third aspect the invention resides in a radio for use in a mobile radio network, including: a user terminal having a transceiver, a power controller and an antenna; and a power booster having an amplifier which is coupled between the transceiver and the antenna to form a signal path for transmission of radio signals by the terminal to the network, wherein the power controller generates a power headroom report for the network not including the power available from the booster, and the power controller correspondingly receives control signals from the network which decrease the power output from the user terminal by the power available from the booster.

In a fourth aspect the invention resides in a radio for use in a mobile radio network, including: a user terminal having a transceiver and an antenna; and a power booster having an amplifier, an amplifier bypass, and a power controller; wherein the booster is coupled between the transceiver and the antenna to form a signal path for transmission of radio signals by the terminal, and the power controller switches the signal path between the amplifier and the amplifier bypass according to transmitter power received from the transceiver. The booster is active at relatively high power output of the UE and is inactive at relatively low power output of the UE in order to comply with LTE requirements for in-band emissions.

In a fifth aspect the invention resides in a booster for use with a UE terminal, including: a pair of switches, an RF power input for connection to an output of the UE, an RF power output for connection to an antenna, an amplifier and an amplifier bypass connected in parallel between the switches, and a controller which operates the switches to connect either the amplifier or the bypass between the power input and the power output, according to power requirements of the UE.

### LIST OF FIGURES

Preferred embodiments of the invention will be described with respect to the accompanying drawings, of which:

FIG. 1 shows how a power booster can increase the coverage of a cell in an LTE network,

FIG. 2 indicates a terminal and booster arrangement in a first embodiment of the invention,

FIG. 3 shows input/output power for the first embodiment,

FIG. 4 indicates a further terminal and booster arrangement in a second embodiment of the invention,

FIG. 5 shows input/output power for the second embodiment,

FIGS. 6, 7 are example power calculations for the second embodiment,

FIG. 8 indicates a further terminal and booster arrangement in a third embodiment of the invention,

FIG. 9 shows input/output power for the third embodiment,

FIGS. 10, 11 are example power calculations for the third embodiment,

FIG. 12 indicates a further terminal and booster arrangement as a fourth embodiment of the invention,

FIG. 13 shows how gain of the booster in FIG. 12 varies as a terminal moves between normal and extended cell areas,

FIGS. 14, 15, 16 are example power calculations for the fourth embodiment, and

FIGS. 17, 18 show progressive introduction and removal of the booster.

### DESCRIPTION OF PREFERRED EMBODIMENTS

Referring to the drawings it will be appreciated that the invention can be implemented in a range of different ways. It will also be appreciated that the LTE embodiments described in this specification are given by way of example only. These embodiments relate to half duplex FDD (frequency division duplex) or TDD (time division duplex) terminals.

In an LTE radio system, uplink power control is a combination of open-loop and closed-loop components. Firstly, the UE selects an Open Loop Operating Point, depending on estimates of downlink path loss and knowledge of the receiver power desired at the eNodeB. The UE output power is further adjusted by a Closed Loop Dynamic Offset, where the network can directly control the UE power with explicit power control commands, based on factors such as the modulation and coding scheme MCS to be used, and multipath fading. Closed loop control can be applied from sub-frame to sub-frame.

Detailed power control formulae are given in ETSI TS 136 213 for the Uplink Control (PUCCH), Uplink Shared (PUSCH) channels and the Sounding Reference Signals (SRS). These formulae follow a common format:

UE Transmit Power (Pcalc)=Open Loop Operating Point+Closed Loop Dynamic Offset+Bandwidth Factor

Open Loop Operating Point=Po+α.PL

Po=Base Operating Level, PL=Path Loss, α=Compensation Factor

The Base Operating Level Po is the desired received power level per resource block at the eNodeB. In theory, Po can be set to any number between −126 and +23 dBm. It can be used to quickly correct for systematic errors in UE power setting, such as path loss measurement errors. Po will depend on the uplink interference level and thus may vary over time. This calculation alone would give a suitable power for the lowest modulation scheme, given the measured path loss and slow fading.

The Open Loop Path Loss PL is based on the level at which the UE receives downlink Reference Signals (RS) from the eNodeB. The Compensation Facto, α lies between 0 and 1 and alters the degree to which UE transmit power responds to Path Loss. It is used for PUSCH and SRS, while for the PUCCH, α always equals 1. Full path loss compensation (α=1) maximizes the quality of service for UEs at the cell edge, but when considering a system with multiple cells, optimum system capacity is achieved with compensation factors of around 0.7 to 0.8.

Closed Loop Dynamic Offset=TF+TPC

TF=Transport Format command, TPC=Transmitter Power Control command

The Open Loop Operating Point sets the UE transmit power for the lowest modulation scheme MCS given the measured path loss. The ΔTF component allows the UE power to be adapted for a particular modulation scheme, reflecting that different minimum S/N ratios are required at the eNodeB for different schemes.

The TPC commands are sent to the UE in messages on the Downlink Control Channel (PDCCH), and the UE is required to check for TPC commands every sub-frame. Two types of TPC command are defined in ETSI TS 136 213—‘accumulation enabled’ TPC (available for PUSCH, PUCCH and SRS), and ‘accumulation not enabled’ TPC (PUSCH only). With ‘accumulation enabled’ TPC commands, each new command signals a change in the UE output power relative to the previous step. This is the default mode and can be used to adjust the power from sub-frame to sub-frame. There are two sets of accumulation enabled TPC values that can be used: (−1, +1) dB and (−1, 0, +1, +3) dB. The maximum power step that can be made with accumulation enabled TPC commands is therefore −1, +3 dB, but the range over which the power can be changed relative to the Open Loop Operating Point is unlimited so long as it stays between the −40 to +23 dBm boundaries. In contrast, ‘accumulation not enabled’ TPC commands ignore previous accumulative TPC commands. Instead ‘accumulation not enabled’ TPC commands signal a power offset from the Open Loop Operating Point. The offsets that can be signalled by an ‘accumulation not enabled’ TPC command are (−4, −1, +1, +4) dB. Thus this mode can only control the power by +/−4 dB around the Open Loop Operating Point, but a change of up to 8 dB can be triggered by a single command.

The UE power per Resource Block (RB) is obtained by adding the Open Loop Operating Point and the Closed Loop Dynamic Offset. To convert this to an overall transmitted power a Bandwidth Factor is added, based on the number of Resource Blocks allocated to the UE. For a larger number of RBs, a higher received power is needed at the eNodeB, meaning a correspondingly higher UE transmit power is required.

Bandwidth Factor=10 log₁₀ M

M=number of Resource Blocks

Once the Open Loop Operating Point and Dynamic Offset are understood the UE power can be controlled to an accuracy of about 1 dB.

Calculated UE Output Power (Pcalc)=[(Po+α.PL)+(ΔTF+TPC)+(10 log₁₀ M)]

This figure must be less than or equal to the maximum UE Output Power permitted in the cell (Pmax):

Actual UE Output Power (P_{UE})=min [Pmax, ((Po+α.PL)+(ΔTF+TPC)+(10 log₁₀ M))]

The Power Headroom can then be calculated by the UE:

Power Headroom=Pmax−Pcalc=Pmax−[(Po+α.PL)+(ΔTF+TPC)+(10 log₁₀ M)]

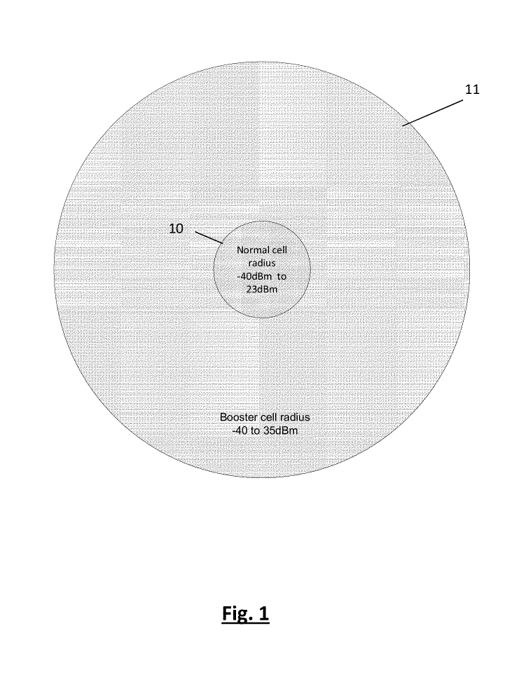

FIG. 1 shows how the coverage of an LTE cell can be increased by boosting the maximum power of an existing UE transmitter from 23 dBm (200 mW) to 35 dBm (about 3 W), as may be suitable for some networks to be used for public utilities or public safety. An additional gain of 12 dBm increases the radius of the original cell 10 by approximately fourfold to the radius of an enhanced cell 11. Boosters may be added to existing terminals, rather than simply increasing the power of their existing amplifiers. However, within the original coverage area, the transmit power is preferably the same as that of an unboosted UE, and the power headroom reports to the eNodeB must still be correct. Changes to the existing UE hardware and power control algorithm are also preferably minimised, with reduced reliance on closed loop power control commands to correct for the presence of the booster.

The term ‘User Equipment” (UE) can refer to a wide range of devices which conform to the LTE standard. It may include a mobile telephone, a mobile radio or a laptop with a suitable wireless adaptor, for example. In general terms, each UE has a processor and a memory which operate software, and usually some associated hardware, to implement a range of functions. Each UE also has an RF transceiver which includes transmit Tx and receive Rx paths for RF signals. These paths include a modem which implements the MCS, typically including a quadrature (I/Q) modulator and demodulator. A typical transceiver portion includes transmit and receive amplifiers which are alternately connected to an antenna through a common signal path. A power control algorithm is provided in software which is typically stored in the memory and implemented by the processor. The algorithm conforms to requirements of the LTE standard and carries out calculations as described above.

FIG. 2 shows a radio terminal including a generally standard UE 20 and a booster 21 that is partially integrated with the UE, and which is switched in or out of the signal path under control of the UE. The booster is coupled between an RF port of the transceiver and the antenna 25. In this example, a conventional UE must be modified with a booster in/out control line, and an internal (P-12 dB) switch. The internal switch scales down the power output of the UE modulator by 12 dB when required in relation to the booster. The booster includes an amplifier 22 and an amplifier bypass 23 which may be alternately switched into the signal path by a switch controller 26. The controller is activated by the UE via the booster in/out control line and/or the Rx/Tx control line. Closed loop TPC commands are not needed from the network to correct for the booster. A low pass filter 24 is also typically included to reduce unwanted outputs to acceptable levels.

In this embodiment, if the UE transmitter power Pcalc is less than +23 dBm, the booster is bypassed and the standard UE transmitter output ‘P’ is selected. This is the UE transmitter output corresponding to Pcalc. If the required output power Pcalc should rise above the standard UE level of +23 dBm, or possibly approach +23 dBm within a small range, the booster is switched in and the UE simultaneously selects the ‘P-12 dB’ power setting. Both are switched together to minimise discontinuities when the booster alone is switched in or out. Should Pcalc then drop below −28 dBm, the booster is bypassed and the UE power control setting P is re-selected. The booster in/out line is not the same as Tx/Rx. In receive mode Rx, the booster is always bypassed.

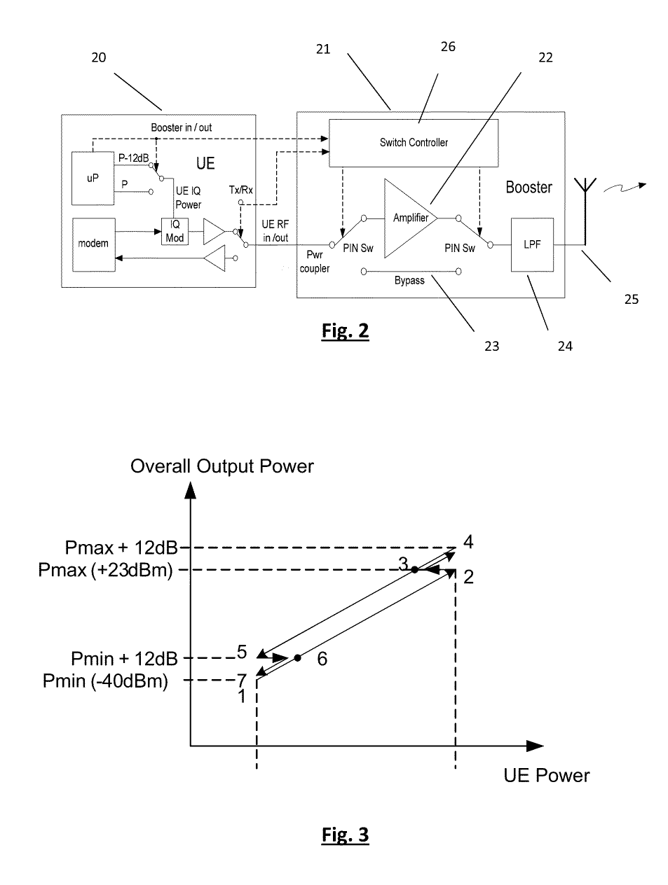

FIG. 3 indicates the UE power output as the UE moves away from, then back towards the eNodeB at the centre of the cell in FIG. 1. The lower line is the UE output power with the booster switched out. The upper line is the UE output power with the booster switched in. The UE switches the booster in when the UE power reaches the standard Pmax of +23 dBm, and switches out when it reaches a boosted Pmin of −28 dBm (ie: −40 dBm+booster gain). No modifications are required to the standard power control algorithm.
P1: The UE is close to eNodeB. Transmit power is about −40 dBm and the booster is bypassed. Power Headroom is 75 dB, as for a standard UE. Transmit power is increased as the UE moves away from the eNodeB towards P2.
P2: The UE approaches or reaches the boundary of the standard cell 10. Transmit power is about +23 dBm and the booster is bypassed. Power Headroom is 12 dB.
P3: The UE is at the standard cell boundary. Overall transmit power is about +23 dBm and the booster has been switched in while the UE output has been correspondingly reduced. Power Headroom is 12 dB.
P4: The UE approaches or reaches the boundary of the standard cell 10. Transmit power is +35 dBm with the booster switched in and the UE output increased to +23 dBm. Power Headroom is 0 dB.
P5: The UE has moves back towards the eNodeB with the booster switched in. Output power reduces under control of the power control algorithm to −28 dBm.
P6: The booster is then bypassed and the nominal UE power setting P is selected. This keeps the output power at −28 dBm, so there is no danger of sudden communication loss.
P7: The remaining dynamic range down to Pmin (−40 dBm) is achieved without the booster.

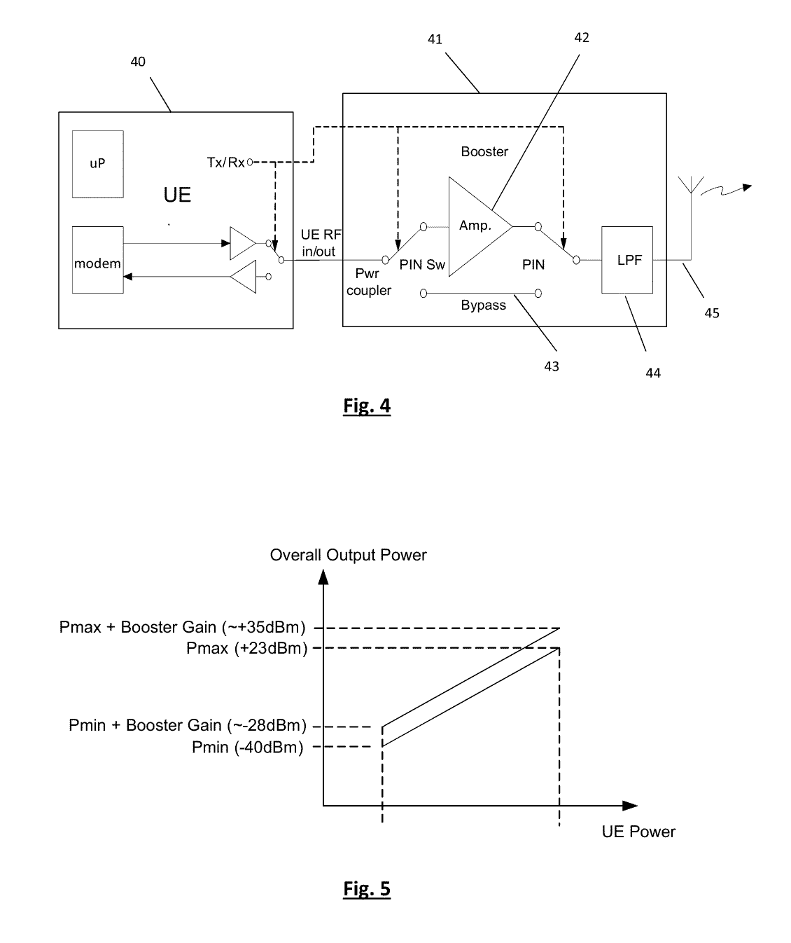

FIG. 4 shows a radio terminal including a generally standard UE 40 with a booster 41 that is always on in Tx mode, but bypassed in Rx mode, under control of the UE. The structure of the booster is generally similar to that of FIG. 2, having an amplifier 42, bypass 43, filter 44 and antenna 45.

FIG. 5 indicates the power output of the combined terminal and booster over the output of the terminal alone. This arrangement will knowingly exceed the Pmax limit of +23 dBm, and the Pmin limit of −40 dBm. A booster with 12 dB gain would give a Pmax of +35 dBm, and Pmin of −28 dBm. The Tx ‘off’ power would be the same, as the PA would be bypassed so the antenna can be used for Rx diversity. Correct operation relies on three changes to the power control algorithm, to ensure the power headroom reports remain correct:
1) The UE must compensate by dropping the initial open loop output power by an amount equal to the gain of the booster. The Open Loop Operating Point becomes:

Open Loop Operating Point=Po+α.PL−Gb

Where Gb=booster gain (¹⁸ 12 dB)

Hence, the actual UE power becomes:

Actual UE Power (P_{(UE)})=min [Pmax, ((Po+α.PL−Gb)+(ΔTF+TPC)+(10 log₁₀ M))]
2) The parameter Pmax is increased to +35 dBm.
3) The Power Headroom calculation must use the original value of Pcalc not the UE output power in to the booster, which is reduced by 12 dB.

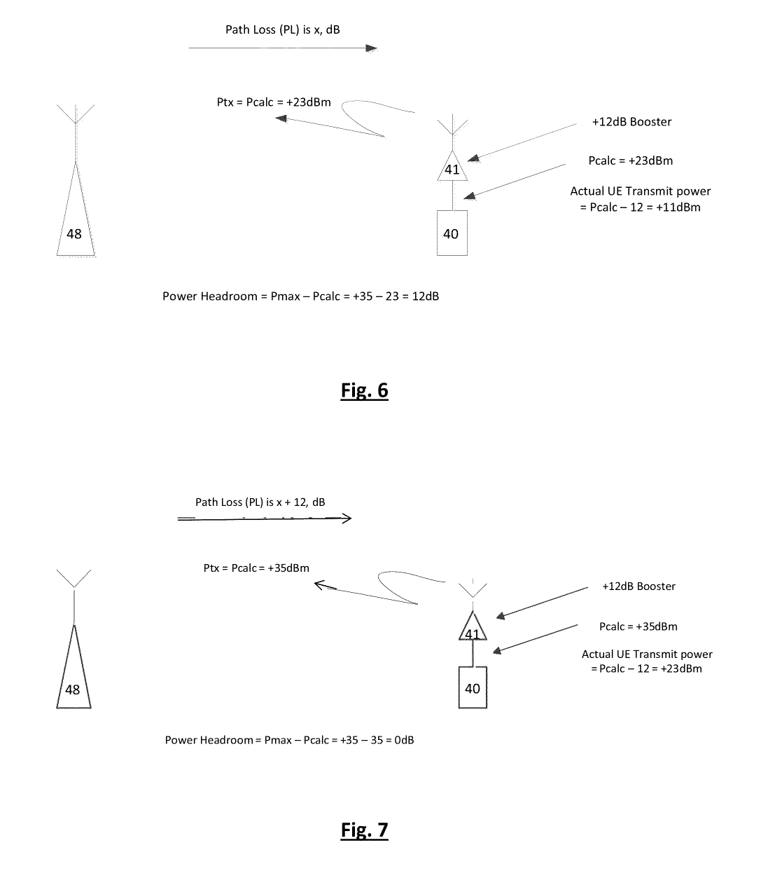

FIGS. 6, 7 are examples showing the power headroom calculation at the edges of a standard cell and an extended cell respectively. Both give the correct value of power headroom as required by the network in determining the MCS and number of resource blocks M in any subsequent grant to the UE. The following terms are used:

Ptx—The actual UE+Booster output power in dBm

Pcalc—The calculated UE output power, in dBm.

P_{(UE)}—The actual UE output power before the booster, in dBm (ie: Pcalc−12 dB)

Pmax—A parameter defining the maximum UE output power.

In FIG. 6, a UE 40 with a booster 41 is at the edge of a standard cell provided by an eNodeB 48. Due to the Path Loss, the power control algorithm calculates Pcalc to be +23 dBm. However, the actual UE power is reduced by the gain of the booster (12 dB) to +11 dBm. The booster then amplifies this up to +23 dBm, so the power headroom is +35−23=12 dB.

In FIG. 7, the UE 40 with booster 41 is at the extended cell edge. Here, due to the Path Loss, the power control algorithm calculates Pcalc to be +35 dBm. However, the actual UE power is reduced by the gain of the booster (12 dB) to +23 dBm. The booster then amplifies this up to +35 dBm, so the power headroom is +35−35=0 dB.

A potential drawback is the higher Pmin of −28 dBm. Assuming the terminals are uniformly distributed throughout the cell, then the terminals that would nominally be transmitting at a level <−28 dBm would be those in an inner circle where the propagation loss is 63 dB less than at the extended cell edge. The area of that ring is about 1/1000 of the area of the cell (ie: 10^{(-63/20).}. In a system with uniformly distributed UEs, fewer than 1 in a 1000 would be transmitting too loudly, and of those very few would be 12 dB too loud since the excess starts at 0 dB from the boundary of the inner ring.

FIG. 8 shows a third embodiment including a UE terminal 80 having a booster 81 that is always on in Tx mode, but bypassed in Rx mode under, control of the UE. In this example a conventional UE need only be modified with a booster in/out control line from the transceiver (same as Tx/Rx in this case). The structure of the booster is generally similar to that of FIG. 2, having an amplifier 82, bypass 83, filter 84 and antenna 85.

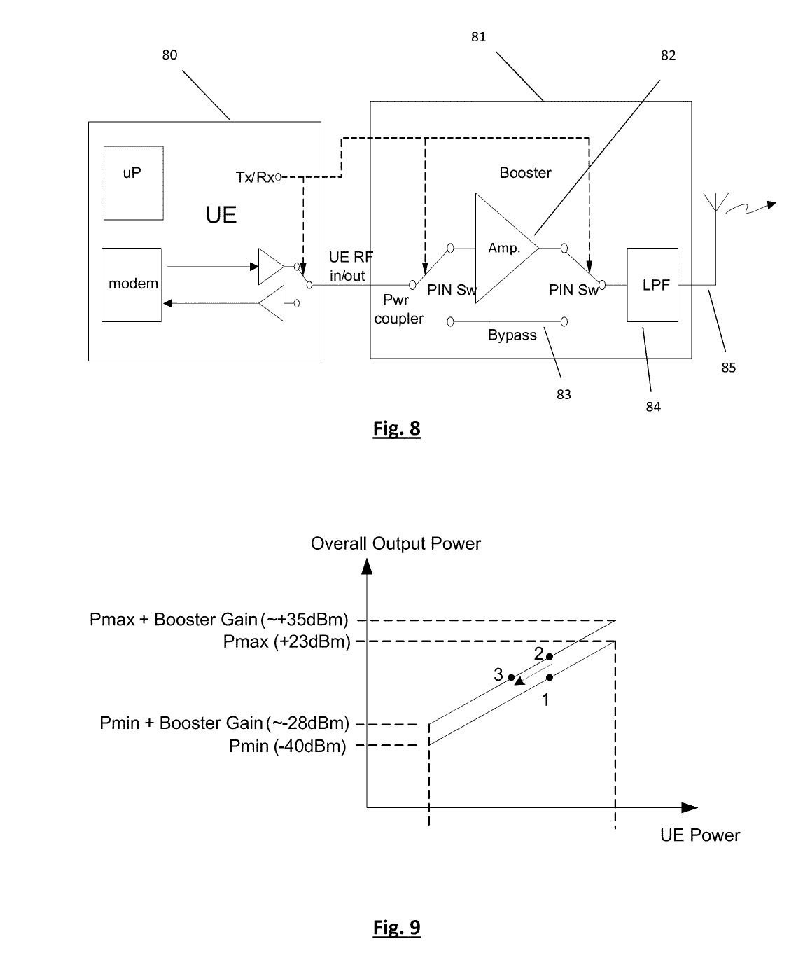

FIG. 9 indicates the power output of the combined terminal and booster over the output of the terminal alone. In this case, it is the network that accounts for the booster gain through the use of Transmitter Power Control (TPC) commands. The UE estimates the path loss and then calculates the open loop operating power as being at point P1. However, the presence of the ‘always on’ booster means the actual power transmitted is at point P2, ie: 12 dB too high. The eNodeB would then notice the UE power is too high and send successive TPC commands to decrementally bring the power back to point P3. This could take up to 12 sub-frames to happen using accumulative TPC commands. Once the power is at point P3, the power headroom calculation is now correct, and as the UE moves around the cell, this 12 dB TPC correction remains.

As with the second embodiment, the booster is ‘always on’ in the third embodiment, so the potential drawback with Pmin being −28 dBm still exists. Thus, there remains a possibility of boosted UEs operating inside an inner boundary interfering with a more distant standard UE situated at the edge of a standard cell, but the effect is minimal as illustrated for the second embodiment.

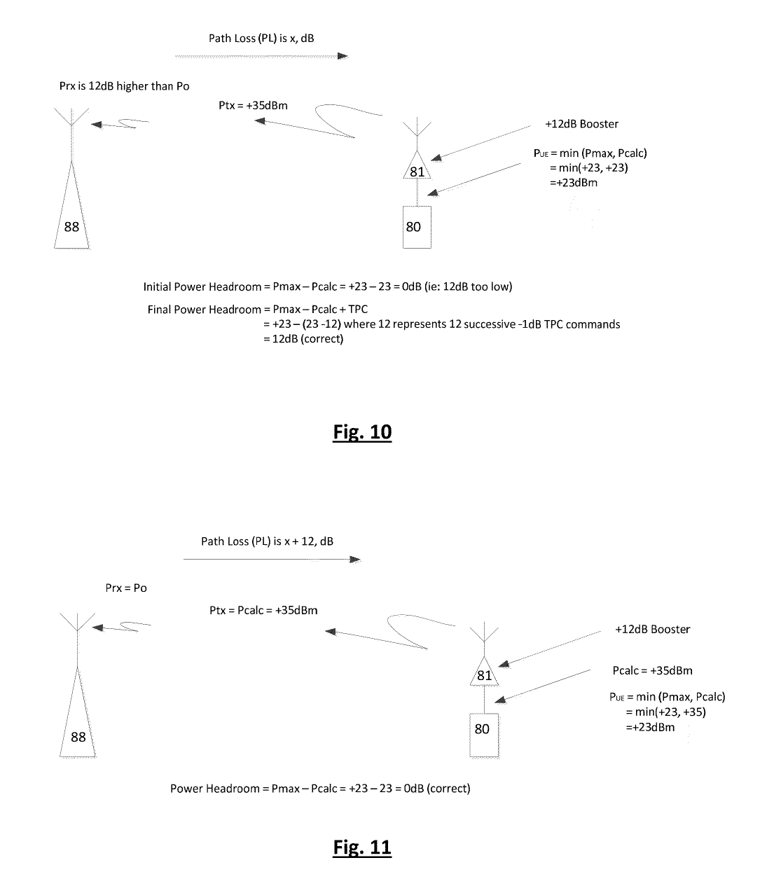

FIGS. 10, 11 are examples showing the power headroom calculation at the edges of a standard cell and an extended cell respectively, using terms as for FIGS. 6, 7. Both give the correct value of power headroom as required by the network in determining the MCS and number of resource blocks M in any subsequent UE grant.

In FIG. 10, a UE 80 with booster 81 is at the edge of a standard cell provided by eNodeB 88. The power control algorithm calculates Pcalc to be +23 dBm. However, the booster amplifies this up to +35 dBm, which means the signal received by the eNodeB will be 12 dB above Po. At this time, the Power Headroom report is 12 dB too low. The eNodeB then sends 12 successive −1 dB TPC commands, which reduce the UE transmitted power Ptx to +23 dBm and correct the Power Headroom report.

In FIG. 11, the UE 80 with booster 81 at the extended cell edge where, due to the Path Loss, the power control algorithm calculates Pcalc to be +35 dBm. However, P_{UE}, the actual UE transmitted power, is +23 dBm (ie: min [Pmax, Pcalc]). The booster then amplifies this up to +35 dBm, so the power received at the eNodeB conveniently is the same as Po. The Power Headroom Report is correct at 0 dB.

FIG. 12 shows a radio terminal including a generally standard UE 120 and a booster 121. The booster is coupled between a UE transceiver Rx/Tx port and the antenna 125. Power output by the UE is detected by the booster so the UE generally does not require modification, and a power controller in the UE generates power headroom reports for the network in the usual way. Closed loop TPC commands from the network adjust the power output by the UE to correct for the booster. The booster includes an amplifier 122 and an amplifier bypass 123 which may be alternately switched into the signal path between the UE and the antenna to increase the power output of the radio when required. An attenuator 126 is connected at the input of the amplifier and together with the amplifier determines the gain of the booster.

Booster 121 includes a power controller 127, a pair of switches 128, and a power detector 129 which determines whether the amplifier and the attenuator are included in the signal path between the UE and the antenna. The power detector determines the RF power output by the UE and activates the power controller to include the attenuator and amplifier when the power output by the UE reaches or increases towards a predetermined level, Pₜᵣᵢₚ. The overall power from the radio can then increase when the radio moves from the normal cell 10 in FIG. 1 into the extended cell 11. Conversely the power detector and/or control signal deactivates the switch controller to bypass the attenuator and amplifier when power output by the UE decreases below Pₜᵣᵢₚ The booster is therefore generally active only when power output by the UE is relatively high. The booster is generally inactive when power output of the UE is low so that LTE requirements for in-band emissions can be met.

The booster 121 in FIG. 12 may also be connected to a transceiver Rx/Tx control line from the UE. This enables the UE to bypass the amplifier 122 when the antenna 125 may be receiving RF signals. In this example a logic AND combines input from both the UE and the power controller to bypass the amplifier.

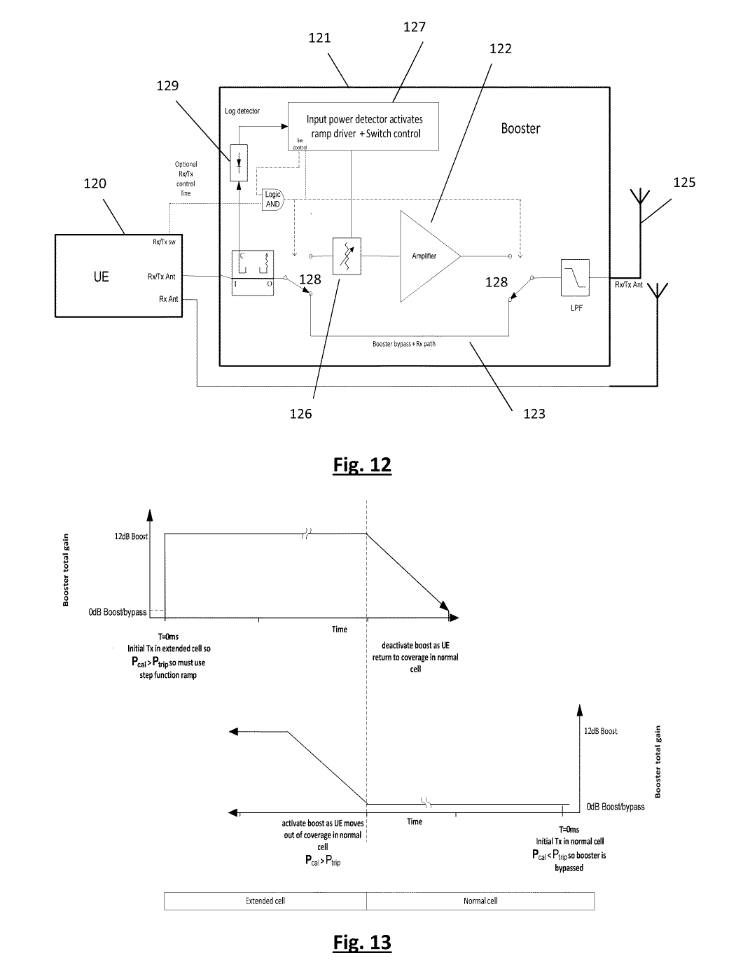

FIG. 13 shows action of the attenuator on overall gain of the booster 121. The power controller drives the attenuator in one of two ramp modes. In one mode the controller operates in 1 dB or continuous steps to ramp the power input to the amplifier up or down at a rate of approximately 1 dB/3 mS when UE power reaches or approaches Ptrip. In another mode the ramp reassembles a step function and is used when the UE is starting to transmit in the extended cell 11. Meanwhile the UE receives closed loop TPC commands from the eNodeB which reduce or increase the power output of the transceiver. TPC commands are typically updated every 3 mS. The net result of the attenuator and the TPC commands in the first mode is a progressive introduction or removal of the booster with minimal change in the overall output power. Possible spurious emissions in the form of carrier leakage and image products may exist due to limitations in the I/Q modulator of the transceiver 20 in FIG. 2. This topology ensures there will be no further degradation to these undesirable products.

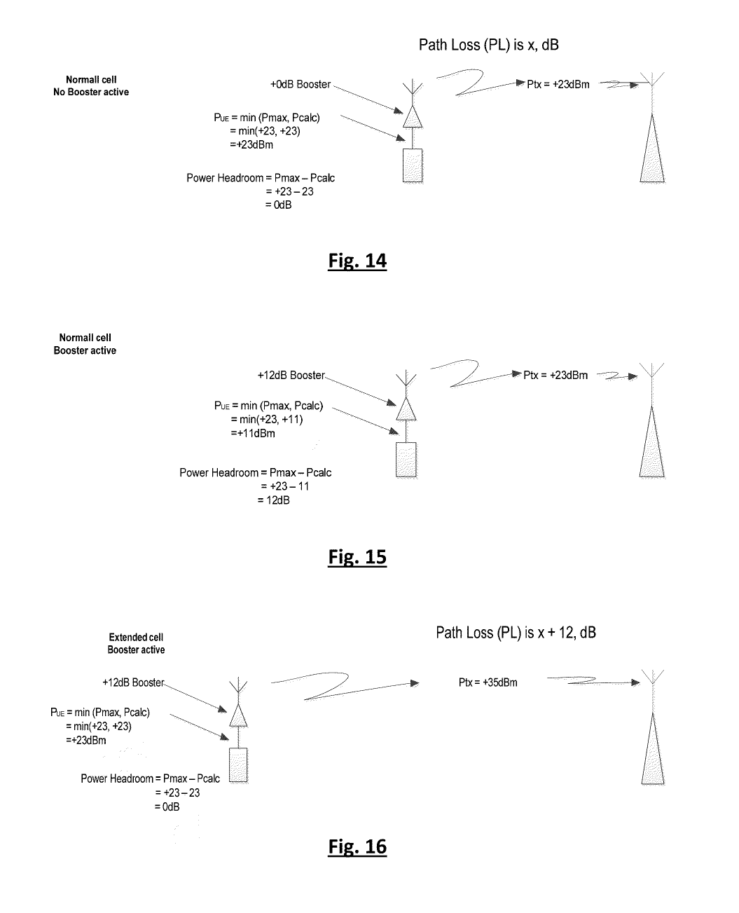

FIGS. 14 and 15 are examples showing power headroom calculations at the edge of the normal cell 10, with and without the booster. FIG. 16 provides example power headroom calculations at the outer edge of the extended cell 11.

In FIG. 14, a UE with booster is near the edge of a standard cell provided by an eNodeB. The power control algorithm in the UE determines Pcalc to be +23 dBm. The booster is inactive so the power headroom report is correct at 0 dB. The overall radio formed by the UE and booster transmits at Ptx=23 dBm.

In FIG. 15, the radio is near the edge of the standard cell and the booster is now active. The eNodeB sends 12 successive −1 dB TPC commands, the transmitted power Ptx remains the same however the Power Headroom report is 12 dB. Pcal reduces to −11 dB

In FIG. 16, the UE with an active booster has now travelled to the far edge of the extended cell where, due to the additional Path Loss, the Pcal has again increased to 23 dBm and the headroom has reduced to 0 dB. The transmitted power is now 35 dBm.

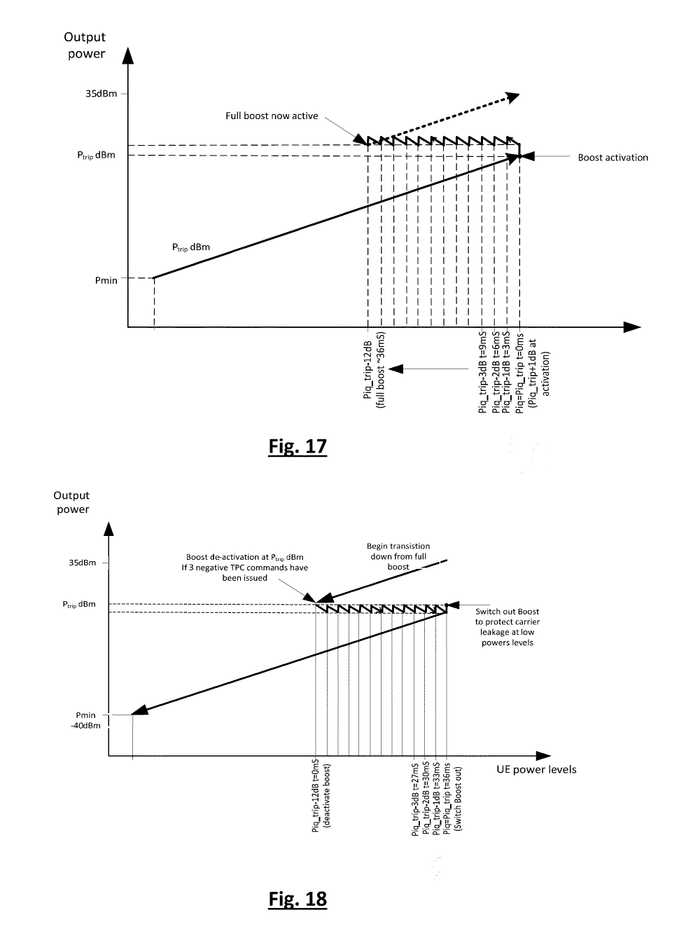

FIGS. 17 and 18 show more detail of the attenuator operation in FIG. 13. When ramping booster power up, the attenuator starts at −11 dB and makes 11 steps of 1 dB taking about 36 mS to reach zero attenuation. If a Voltage Variable Attenuator (VVA) is utilised the steps will be continuous. When ramping booster power down, the attenuator starts at 0 dB and makes 11 steps of −1 dB taking about 36 mS to reach 11 dB attenuation. The duration of the progressive ramp is ramp programmable. In each case TPC commands counter the action of the attenuator to maintain overall power from the radio formed by the combined UE and booster at approximately Ptrip, as the radio moves from the normal cell 10 to the extended cell 11.

1. A radio for use in a mobile radio network, including:
a user terminal having a transceiver, a power controller and an antenna; and
a power booster having an amplifier and an amplifier bypass, under control of the user terminal;
wherein the booster is coupled between the transceiver and the antenna to form a signal path for transmission of radio signals by the terminal, and
the power controller switches the signal path between the amplifier and the amplifier bypass according to transmitter power required from the user terminal.

2. A radio according to claim 1 wherein the power controller switches the booster into the signal path when the required transmitter power reaches or approaches a maximum power available from the transceiver, and correspondingly decreases the power provided by the transceiver.

3. A radio according to claim 2 wherein the power controller switches the booster out of the signal path when the required transmitter power is less than power available from the booster alone.

4. A radio according to claim 1 wherein the power controller generates a power headroom report which includes power available from the booster.

5. A radio for use in a mobile radio network, including:
a user terminal having a transceiver, a power controller and an antenna; and
a power booster having an amplifier which is coupled between the transceiver and the antenna to form a signal path for transmission of radio signals by the terminal to the network,
wherein the power controller generates a power headroom report for the network including the power available from the booster, and
the power controller correspondingly calculates power output from the user terminal including a decrease by the power available from the booster.

6. A radio according to claim 5 wherein the power controller generates headroom reports according to:
Power Headroom=Pmax−Pcalc
wherein Pmax includes the power available from the booster.

7. A radio according to claim 5 wherein the power controller calculates power output from the user terminal according to:
Output Power (P_{(UE)})=min [Pmax, ((Po+α.PL−Gb)+(ΔTF+TPC)+(10 log₁₀ M))]
wherein Gb is the power available from the booster.

8. A radio for use in a mobile radio network, including:
a user terminal having a transceiver, a power controller and an antenna; and
a power booster having an amplifier which is coupled between the transceiver and the antenna to form a signal path for transmission of radio signals by the terminal to the network,
wherein the power controller generates a power headroom report for the network not including the power available from the booster, and
the power controller correspondingly receives control signals from the network which decrease the power output from the user terminal by the power available from the booster.

9. A radio according to claim 8 wherein the control signals received from the network decrement the power output by the user terminal over a sequence of subframes.

10. A radio for use in a mobile radio network, including:
a user terminal having a transceiver and an antenna; and
a power booster having an amplifier, an amplifier bypass, and a power controller;
wherein the booster is coupled between the transceiver and the antenna to form a signal path for transmission of radio signals by the terminal, and
the power controller switches the signal path between the amplifier and the amplifier bypass according to transmitter power received from the transceiver.

11. A radio according to claim 10 wherein the amplifier and the amplifier bypass are connected in parallel between a pair of switches, and the power controller operates the switches to connect either the amplifier or the amplifier bypass into the signal path.

12. A radio according to claim 10 wherein the power controller switches the amplifier into the signal path when the transmitter power from the transceiver reaches or approaches a trigger level, and closed loop commands from the network correspondingly decrease the power provided by the transceiver.

13. A radio according to claim 10 wherein the booster includes an attenuator connected at the input of the amplifier, and the power controller ramps the attenuator down or up to correspondingly increase or decrease power available from the booster.

14. A radio according to claim 13 wherein the user terminal receives closed loop commands from the network as adjustments for power output by the booster when the attenuator is ramped.

15. A radio according to claim 10 wherein the power controller generates a power headroom report for the network which is increased by the gain of the booster.

16. A radio according to claim 10 wherein the booster is inactive when power output by the transceiver is low.

17. A booster for use with a UE terminal, including:
a pair of switches,
an RF power input for connection to an output of the UE,
an RF power output for connection to an antenna,
an amplifier and an amplifier bypass connected in parallel between the switches, and
a controller which operates the switches to connect either the amplifier or the bypass between the power input and the power output, according to power requirements of the UE.

18. A booster according to claim 17 wherein the controller operates the switches according to commands from the UE.

19. A booster according to claim 17 wherein the controller operates the switches according to power output received from the UE.

20. A booster according to claim 17 further including an attenuator connected at the input of the amplifier, wherein the controller ramps the attenuator down or up to correspondingly increase or decrease power available from the booster.

21. A booster according to claim 17 which is active at relatively high power output of the UE and is inactive at relatively low power output of the UE.
